(19) United States
(12) Patent Application Publication
(10) Pub. No.: US 2013/0232740 A1
(43) Pub. Date: Sep. 12, 2013

(54) Elastic Clip

(71) Applicant: Hai Wang, Kwun Tong (HK)

(72) Inventor: Hai Wang, Kwun Tong (HK)

(21) Appl. No.: 13/416,078

(22) Filed: Mar. 9, 2012

(51) Int. Cl. B42F 1/04; F16B 2/20

(52) U.S. Cl. 24/535

(57) ABSTRACT

The invention relates to a elastic clip, includes two holding parts side by side, a handle is settled on each of the holding parts, the elastic clip also includes a elastic compressed part which is joined with the holding parts settled between the handles, the elastic compressed part is shaped with bending spring steel wire, and the elastic compressed part makes an sharp angle between the two handles; When the handles are pressed, the two holding parts will form an opening, while the pressure disappear, the opening will close up under the effect of the elastic-restoring force of the elastic compressed part. The elastic compressed part of the elastic clip is shaped with a spring steel wire, which makes the elastic clip is portable, and at the same time, the consumption of the raw material will not increase even if the size of the elastic clip is expanding.

### FIELD OF THE INVENTION

The invention relates to stationery, especially an elastic clip used for clamping the documents and other things.

### BACKGROUND OF THE INVENTION

Elastic clip is common stationery used for clamping the documents or other things. It normally includes handles and elastic compressed parts. In the prior art, the elastic compressed parts of the elastic clip are made of a whole elastic metal plate, and we found that this kind of elastic clip wasn't portable when the elastic clip was in big size, and the consumption of the raw material and the cost of production will increase.

### SUMMARY OF THE INVENTION

It's an object of the invention to overcome this problem.

According to the invention, a elastic clip is provided, which comprises two holding parts side by side, a handle is settled on each of the holding parts, the elastic clip also includes a elastic compressed part which is joined with the holding parts settled between the handles, the elastic compressed part is shaped with bending spring steel wire, and the elastic compressed part makes an sharp angle between the two handles. When the handles are pressed, an opening will be formed between the two holding parts, while the pressure disappear, the opening will close up under the effect of the elastic-restoring force of the elastic compressed part.

In the present invention, the elastic compressed part further includes the first compressed unit and the second compressed unit joined with the first compressed unit by a elastic arm, and the first and second compressed unit are all shaped with bending spring steel wire.

In the present invention, the first and second compressed unit all include connecting part, horizontal parts which stretched from the end of the connecting part respectively, and bending parts which stretched from the end of the horizontal parts respectively; the two bending parts are placed together which makes a sharp angle between the two bending parts.

The bending parts of the first compressed unit are joined with one end of the holding parts, while the bending parts of the second compressed unit are joined with the other end of the holding parts; and the connecting parts of the first and second compressed part are joined with the elastic arm.

In the present invention, the connecting part, the horizontal part and the bending part are in one piece with a spring steel wire.

In the present invention, the elastic arm is curved shape which is one bending molding with a rectangular metal plate, and the first and second compressed parts are all in the cavity of the elastic arm.

In the present invention, the handles are in one piece with a spring steel wire.

In the present invention, each of the handles includes a circular pressed area with an opening, and pressed arms stretched downwardly from the two ends of the opening respectively.

The beneficial effects of the present invention: the elastic compressed part of the elastic clip is in one piece with a spring steel wire, which makes the elastic clip is portable, and at the same time, the consumption of the raw material will not increase even if the size of the elastic clip is expanding.

### BRIEF DESCRIPTION OF THE DRAWINGS

An elastic clip according to the invention will now be described by way of example with reference to the accompanying drawings in which:

FIG. 1 is schematic diagram of the elastic clip;

FIG. 2 is the side view of the elastic clip;

FIG. 3 is the front view of the elastic clip;

FIG. 4 is the vertical view of the elastic clip;

FIG. 5 is the bottom view of the elastic clip.

### DETAILED DESCRIPTION OF THE PREFERRED EMBODIMENTS

These and other advantages, aspects and novel features of the present invention, as well as details of an illustrated embodiment thereof, will be more fully understood from the following description and drawings, while various embodiments of the present invention have been presented by way of example only, and not limitation.

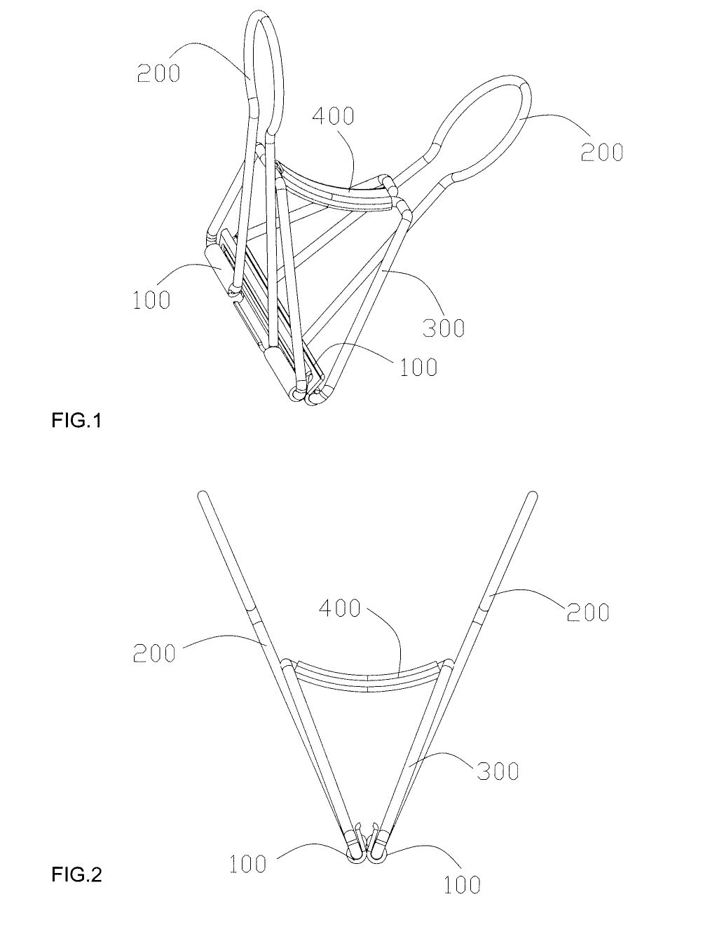

As shown in FIG. 1-2, the elastic clip includes two holding parts 100 side by side, a handle 200 is settled on each of the holding parts 100, the elastic clip also includes a elastic compressed part 300 which is joined with the holding parts 100 settled between the handles 200. The elastic compressed part 300 can resist pressure, and supply the clamping force to the holding parts 100. The elastic compressed part 300 is shaped with bending spring steel wire, and the elastic compressed part 300 makes a sharp angle between the two handles 200. The sharp angle between the two handles 200 can make it convenient for users to put force to the handles 200. And it is comprehensible that if the angle is obtuse angle or right angle, it will be very inconvenient for users to put force to the handles 200.

Like most clips, When the handles 200 are pressed, the two holding parts 100 will form an opening used for receipting articles , while the pressure disappear, the opening will close up under the effect of the elastic-restoring force of the elastic compressed part 300 until clamping the articles.

In view of the elastic clip shaped with bending spring steel wire, as a main part of the elastic clip, the elastic compressed part 300 is substantially low in cost, the weight of the elastic clip and the consumption of the raw material.

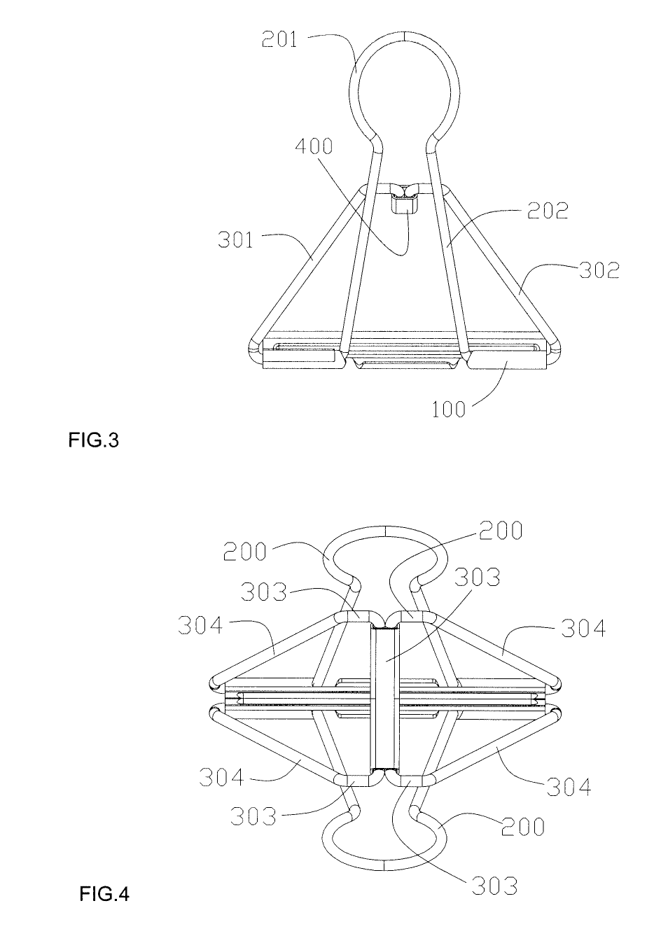

As shown in FIG. 3, the elastic compressed part 300 further includes the first compressed unit 301 and the second compressed unit 302 joined with the first compressed unit 301 by a elastic arm 400, and the first and second compressed unit are all shaped with bending spring steel wire. It is worth of note that the elastic compressed part 300 can be molded in one, in a way, it is easier to be assembled.

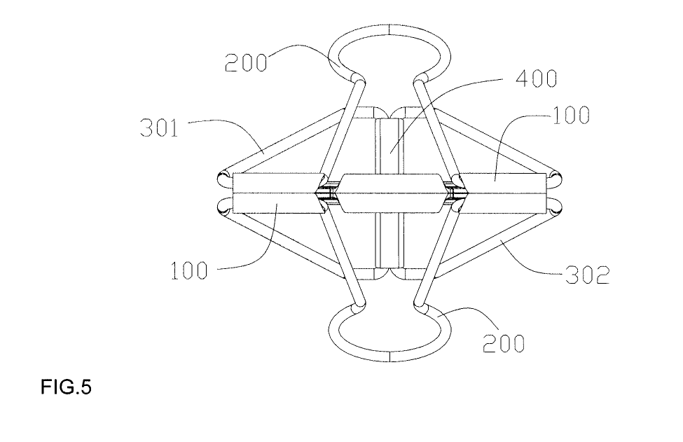

As shown in FIG. 4-5, the first and second compressed unit all include connecting part (which is not signaled), horizontal parts which stretched from the ends of the connecting part respectively, and bending parts which stretched from the ends of the horizontal part 303 respectively; the ends of the two bending parts 304 are placed together which makes a sharp angle between the two bending parts 304, that can obviously be seen in FIG. 4, the sharp angle between the two bending parts 304 is also convenient for the users to put strength. It is worth to note that the angle between the horizontal part 303 and the bending part 304 can make the whole elastic compressed part 300 has a different shape, for example, when the angle is obtuse angle, the whole elastic compressed part 300 is triangle, while the angle is right angle, we can imagine that the whole elastic compressed part 300 is rectangle. About this, the users can design the shape of the elastic compressed part 300 according to their own needs.

Besides, the bending parts 304 of the first compressed unit 301 are joined with one ends of the holding parts 100, while the bending parts 304 of the second compressed unit 302 are joined with the other ends of the holding parts 100; and the connecting parts of the first and second compressed part are joined with the elastic arm 400. When the handles 200 are under the pressure of closing, the pressure will be transferred to the horizontal part 303, and the horizontal part 303 will transfer the pressure to the elastic arm 400, the elastic deformation occurs which will cause to the opening between the two holding parts 100, when the pressure on the handles 200 disappear, the two holding parts 100 will close up so as to clamping the articles. It is preferable that the connecting part, the horizontal part 303 and the bending part 304 are integrated with a spring steel wire.

In addition, as is shown in FIG. 1-2, the elastic arm 400 has a certain curvature which is for the consideration of the force, and the elastic arm 400 can be one bending molding with a rectangular metal plate, and the first and second compressed parts are all in the cavity of the elastic arm 400, that is, the elastic arm 400 wrap the first and second compressed parts together.

In the preferred embodiment of the present invention present invention, the handles are one bending molding with a spring steel wire. And as shown in FIG. 3, the handles 200 include a circular pressed area 201 with an opening, and pressed arms 202 stretched downwardly from the two ends of the opening respectively. The pressed area 201 is rounded which can make it convenient for users to put strength, and the sharp angle between the two pressed arms 202 can improve the stability when the pressed area 201 is under pressure.

1. An elastic clip, includes two holding parts side by side, a handle is settled on each of the holding parts, the elastic clip also includes a elastic compressed part which is joined with the holding parts settled between the handles, the elastic compressed part is shaped with bending spring steel wire, and the elastic compressed part makes an sharp angle between the two handles;
When the handles are pressed, the two holding parts will form an opening, while the pressure disappear, the opening will close up under the effect of the elastic-restoring force of the elastic compressed part.

2. The elastic clip as in claim 1, wherein the elastic compressed part further includes the first compressed unit and the second compressed unit joined with the first compressed unit by a elastic arm, and the first and second compressed unit are all shaped with bending spring steel wire.

3. The elastic clip as in claim 2, wherein the first and second compressed unit all include connecting part, horizontal parts which stretched from the ends of the connecting part respectively, and bending parts which stretched from the ends of the horizontal parts respectively; the two bending parts are placed together which makes a sharp angle between the two bending parts;
The bending parts of the first compressed unit are joined with one end of the holding parts, while the bending parts of the second compressed unit are joined with the other end of the holding parts; and the connecting parts of the first and second compressed part are joined with the elastic arm.

4. The elastic clip as in claim 3, wherein the connecting part, the horizontal parts and the bending parts are in one piece with a spring steel wire.

5. The elastic clip as in claim 3, wherein the first and second compressed unit all include connecting part, horizontal part which stretched from the end of the connecting part respectively, and bending parts which stretched from the ends of the horizontal part respectively; the two bending parts are placed together which makes a sharp angle between the two bending parts;
The bending parts of the first compressed unit are joined with one end of the holding parts, while the bending parts of the second compressed unit are joined with the other end of the holding parts; and the connecting parts of the first and second compressed part are joined with the elastic arm.

6. The elastic clip as in claim 1, wherein the handles are in one piece with a spring steel wire.

7. The elastic clip as in claim 1, wherein the handles include a circular pressed area with an opening, and pressed arms stretched downwardly from the two ends of the opening respectively.
